(19) United States
(12) Patent Application Publication
(10) Pub. No.: US 2006/0122800 A1
(43) Pub. Date: Jun. 8, 2006

(54) System and method for providing adjustments for a compass

(76) Inventors: Kristi A. Haverkamp, Chandler, AZ (US); Bruce E. Geren, Chandler, AZ (US); Carlos Liendo, Plantation, FL (US); Orlando J. Moreno, Fort Lauderdale, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/005,982

(22) Filed: Dec. 7, 2004

(51) Int. Cl. G01C 17/38

(52) U.S. Cl. 702/92

(57) ABSTRACT

The invention concerns a method (300) and system (100) for providing adjustments for a compass (126). The method can include the steps of receiving (312) geographical positional information from a communications network (110), generating (314) a declination value based on the geographical positional information and calibrating (330) a reading for the compass using the declination value. The receiving, generating and calibrating steps can be performed at a portable electronic device (114) containing the compass. As an example, the geographical positioning information can be based on at least one of latitudinal and longitudinal coordinates, an area code and a postal delivery code.

### BACKGROUND OF THE INVENTION

1. Field of the Invention

This invention relates in general to compasses and more particularly, to systems and methods for adjusting compasses.

2. Description of the Related Art

In today's marketplace, consumers have numerous portable electronic devices, such as cellular telephones and personal digital assistants, from which to choose. Manufacturers are constantly adding new features to such devices. For example, many cellular telephones come equipped with compasses, which can provide a user with the direction in which he or she is traveling. As is known in the art, compasses, whether digital or analog in nature, detect the magnetic field lines of the earth to generate its directional or bearing readings. One disadvantage of a compass is that it detects the magnetic north pole of the earth, which is not positioned concentrically with true north, i.e., the North Pole of the earth. This deviation can lead to inaccurate readings for the compass.

### SUMMARY OF THE INVENTION

The present invention concerns a method for providing adjustments for a compass. The method can include the steps of receiving geographical positional information from a communications network, generating a declination value based on the geographical positional information and calibrating a reading for the compass using the declination value. In one arrangement, the receiving, generating and calibrating steps can be performed at a portable electronic device containing the compass.

The method can also include the steps of assigning a grid to a geographical area, assigning a positional marking to sections of the grid, assigning a declination value to sections of the grid and transmitting to the portable electronic device the geographical positional information associated with the section of the grid in which the portable electronic device currently operates. Moreover, the step of generating a declination value can include comparing the received geographical positional information with the positional markings and selecting an assigned declination value based on the comparing step.

The step of calibrating the reading of the compass can include calibrating the reading of the compass using the selected declination value for the section of the grid in which the portable electronic device currently operates. The method can also include the steps of storing in the portable electronic device the assigned declination values for the sections of the grid and periodically updating the assigned declination values for the sections of the grid stored in the portable electronic device.

In another arrangement, the method can include the steps of storing in the portable electronic device at least one declination model and declination coefficients that are associated with at least one region of the earth and using the declination model and the declination coefficients to generate the declination value. The portable electronic device can also use this declination value to calibrate readings of the compass. The method can also include periodically updating the declination coefficients stored in the portable electronic device.

In one embodiment, the receiving, generating and calibrating steps can be performed based on at least one of the following occurrences: powering up the portable electronic device; manual requesting from a user; the portable electronic device reentering a range of the communications network; and the portable electronic device moving from a first portion of the communications network to a second portion of the communication network. The method can also include storing the declination value in the portable electronic device and when the portable electronic device leaves the range of the communication network after a predetermined amount of time, accessing the geographical positional information from a global positioning system receiver. In this embodiment, the generating and calibrating steps can be performed based on the geographical positioning information from the global positioning system receiver. As an example, the geographical positional information is based on at least one of latitudinal and longitudinal coordinates, an area code and a postal delivery code.

The present invention also concerns a system for providing compass adjustments. The system can include a compass for providing directional information, a receiver for receiving geographical information from a communications network and a processor coupled to the compass and the receiver. The processor can be programmed to generate a declination value based on the geographical positional information and to calibrate a reading for the compass using the declination value. The compass, the receiver and the processor can be part of a portable electronic device. The system can also include suitable software and circuitry for performing the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for providing adjustments for a compass in accordance with an embodiment of the inventive arrangements;

FIG. 2 illustrates a block diagram of a portable electronic device in accordance with an embodiment of the inventive arrangements;

FIG. 3 illustrates a portion of a method for providing adjustments for a compass in accordance with an embodiment of the inventive arrangements;

FIG. 4 illustrates a grid assigned to a geographic region in accordance with an embodiment of the inventive arrangements;

FIG. 5 illustrates another portion of the method of FIG. 3 in accordance with an embodiment of the inventive arrangements; and

FIG. 6 illustrates another method for providing adjustments for a compass in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a method and system for providing adjustments for a compass. In one arrangement, the method can include the steps of receiving geographical positional information from a communications network, generating a declination value based on the geographical positional information and calibrating a reading for the compass using the declination value. As an example, the receiving, generating and calibrating steps can be performed at a portable electronic device containing the compass.

There are at least two different scenarios for carrying out the method recited above. For example, a grid can be assigned to a geographical area, and geographical positional information can be assigned to one or more sections of the grid. Declination values can also be assigned to the sections of the grid. In addition, the geographical positional information associated with a section when the portable electronic device is within that section of the grid can be transmitted to the portable electronic device, which can use this information to select an appropriate declination value.

As another example, a declination model and declination coefficients that are associated with at least one region of the earth can be stored in the portable electronic device. The portable electronic device can use the declination model and the declination coefficients to generate the declination value. In either alternative, the geographical positioning information can be based on, for example, at least one of latitudinal and longitudinal coordinates, an area code and a postal delivery code.

Referring to FIG. 1, a system 100 for providing adjustment for a compass is shown. In one arrangement, the system can include a communications network 110, which, as an example, can be a wireless communications network. As those of skill in the art will appreciate, the communications network 110 may include one or more base stations 112 that communicate with one or more portable electronic devices 114 over wireless communications links 116. As an example, the portable electronic devices 114 may be cellular telephones, two-way radios, personal digital assistants or any other suitable mobile communications unit that has a compass (not shown here). Those of skill in the art will also appreciate that the portable electronic devices 114 may also communicate directly with one another, i.e., without the assistance of the communications network 110.

As will be explained below, the communications network 110 can send geographical positional information to the portable electronic devices 114. Once received, the portable electronic devices 114 can generate declination values and can use these values to calibrate the compass. This calibration can serve to provide a more accurate determination of true north or some other reference point from which the compass determines its bearings. Although the communications network 110 may be shown here as a cellular-based system, it is important to note that the invention is not so limited. In fact, the communications network 110 can be any network that can relay relevant geographical positional information to the portable electronic devices 114.

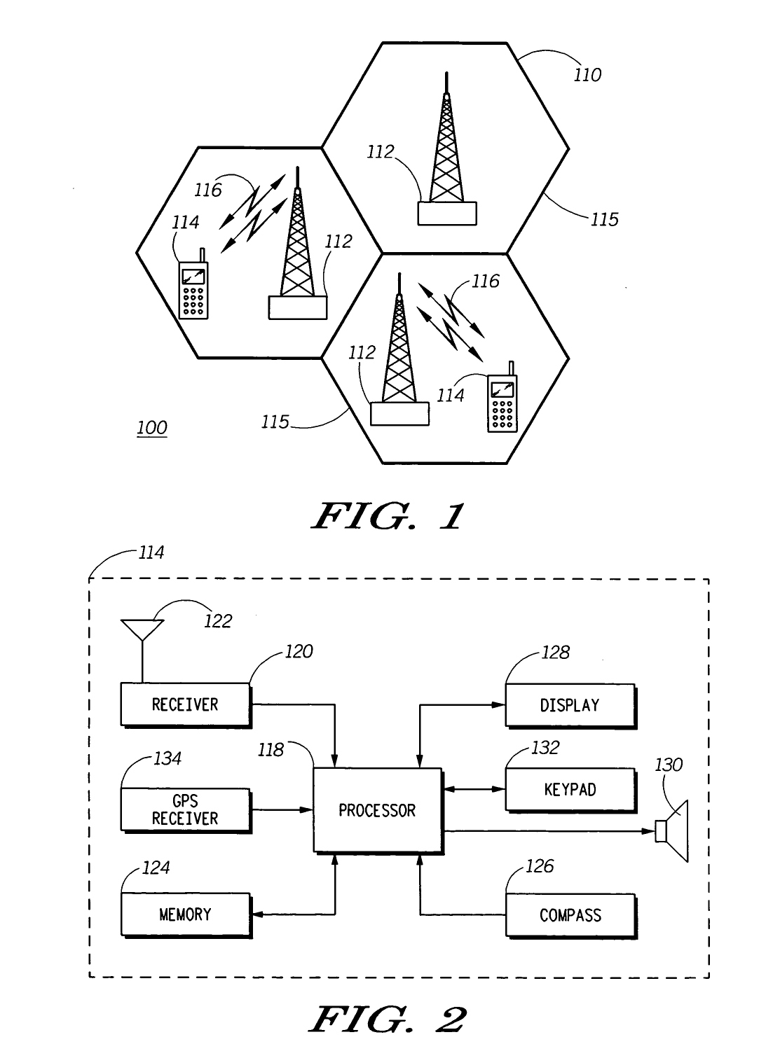

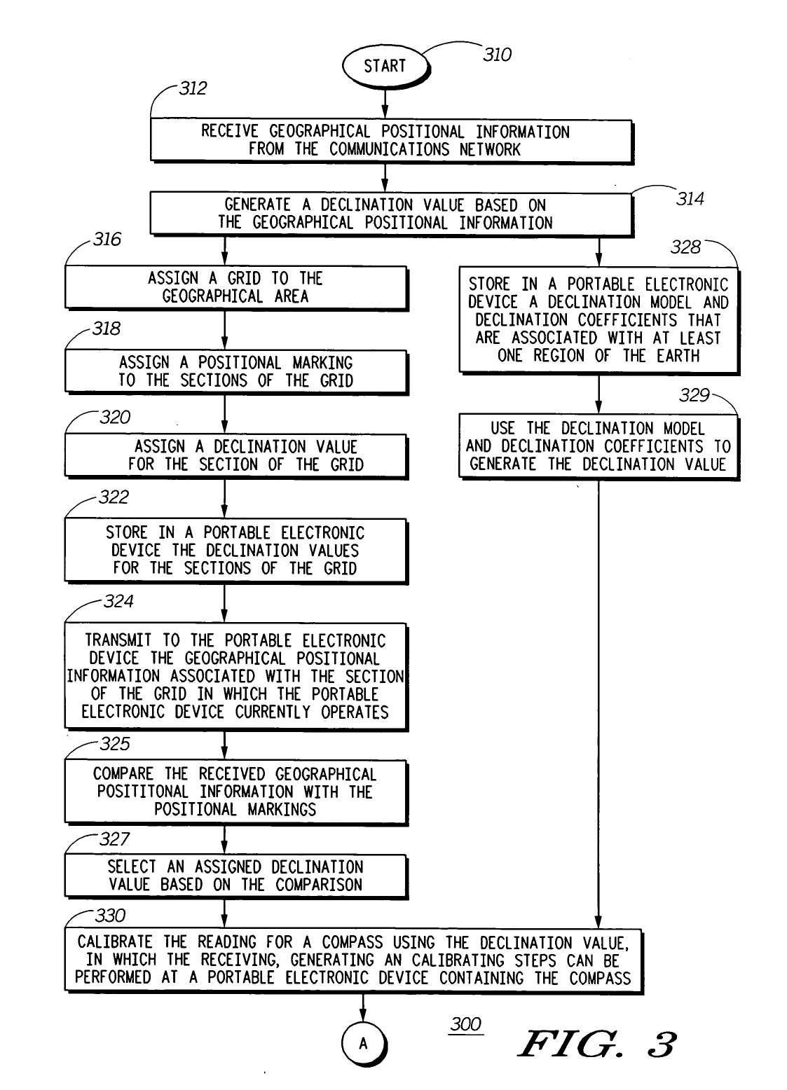

Referring to FIG. 2, a block diagram of an example of a portable electronic device 114 is shown. In one arrangement, the portable electronic device 114 can include a processor 118, a receiver 120, an antenna 122 coupled to the receiver 120, a memory 124 and a compass 126. In one particular embodiment, the portable electronic device 114 can also include a display 128, a speaker 130 and a keypad 132 to permit information to be displayed or broadcast to a user and to also allow the user to provide data to the portable electronic device 114. Of course, the portable electronic device 114 can include any other suitable user interface. As an option, the portable electronic device 114 may also have a global positioning system (GPS) receiver 134. The receiver 120, the memory 124, the compass 126, the display 128, the speaker 130, the keypad 132 and the GPS receiver 134 can all be coupled to the processor 118 to permit the transfer of signals between the processor 118 and these components where needed.

The antenna 122 can capture wireless signals, such as those broadcast by the communications network 110, and can relay these signals to the receiver 120. The receiver 120 can process these signals in accordance with well-known principles and can transfer them to the processor 118. As explained earlier, geographical positional information can be included in these signals. The compass 126, as is known in the art, can detect the magnetic field lines of the earth and, using the magnetic north pole, can provide a direction or bearing to the processor 118. The processor 118 can then signal the display 128 to display the direction or bearing. The processor 118 can also signal the speaker 130 to broadcast the direction or bearing, if so desired.

The memory 124 can be used to store any suitable form of data, which the processor 118 can access. As will be explained below, when the processor 118 receives geographical positional information from the receiver 120, the processor 118 can generate a declination value based on the geographical positional information. The declination values can be stored in the memory 124. In addition, declination models and declination coefficients can also be stored in the memory 124, which the processor 118 can use to generate declination values. Once a declination value is generated, the processor 118 can calibrate a reading for the compass 126, which can provide a more accurate designation of true north or some other reference point. The processor 118 can cause the calibrated reading to be, for example, displayed on the display 128 or broadcast on the speaker 130.

In one arrangement, if for some reason the geographical positional information is inaccurate, unavailable or outdated, the GPS receiver 134 can provide geographical positioning information to the processor 118 to enable the processor 118 to calibrate the readings of the compass 126.

Referring to FIG. 3, a method 300 for providing adjustments to a compass is shown. To describe the method 300, reference will be made to FIGS. 1, 2 and 4, although it is understood that the method 300 can be implemented in any other suitable device or system. Moreover, the invention is not limited to the order in which the steps are listed in the method 300. In addition, the method 300 can contain a greater or a fewer number of steps than those shown in FIGS. 3 and 5.

At step 310, the method 300 can begin. At step 312, geographical positional information can be received from a communications network. For example, referring to FIGS. 1 and 2, the portable electronic device 114 can receive geographical positional information from the communications network 110. In particular, the portable electronic device 114 may be within a transmitting range of a base station 112. The base station 112 can transmit relevant geographical positional information, and the antenna 122 of the portable electronic device 114 can capture this transmission. The receiver 120 can process this positional information and can transfer it to the processor 118.

For purposes of the invention, the term geographical positional information can mean any suitable type of information that can provide the portable electronic device 114 with a general indication as to where the portable electronic device 114 is currently located. As an example, this term may include positional coordinates, such as latitude and longitude, of the base station 112 from which the portable electronic device 114 is currently receiving transmissions. Of course, the invention is not so limited, as other suitable examples may include an area code or a postal delivery code, e.g., a zip code, in which the base station 112 is located. In one arrangement, the base station 112 may transmit to the portable electronic device 114 the geographical positional information over any suitable communications channel, such as a broadcast control channel (BCCH).

Referring back to the method 300 of FIG. 3, a declination value can be generated based on the geographical positional information. There are at least two ways to generate the declination value, one of which is presented in steps 316 to 327; the other one is presented in steps 326 and 328.

At step 316, a grid can be assigned to a geographical area. At step 318, a positional marking can be assigned to one or more sections of the grid. In addition, a declination value can be assigned to the sections of the grid, as shown at step 320, and these declination values can be stored in a portable electronic device, as shown at step 322. At step 324, the geographical positional information associated with the section of the grid in which the portable electronic device currently operates can be transmitted to the portable electronic device. At step 325, the received geographical positional information can be compared with the positional markings, and an assigned declination value can be selected based on this comparison, as shown at step 327.

In the second process, at step 328, one or more declination models and declination coefficients that can be associated with at least one region of the earth can be stored in the portable electronic device. The declination model and the declination coefficients can be used to generate declination values, as shown at step 329.

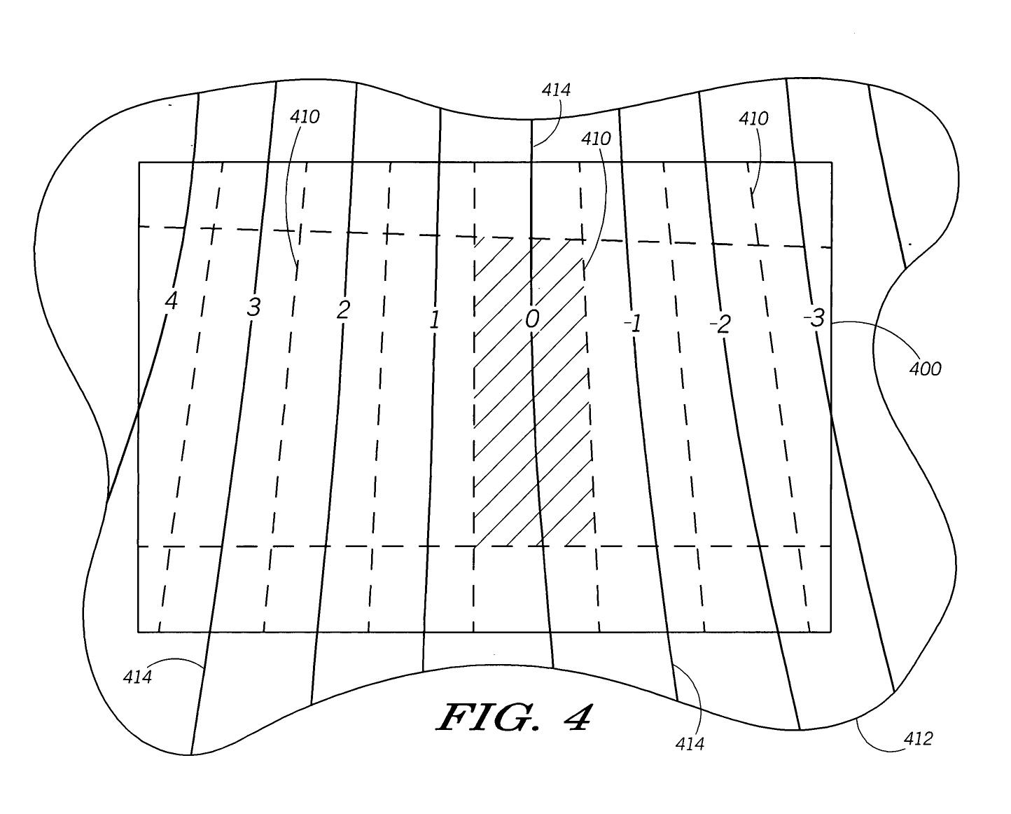

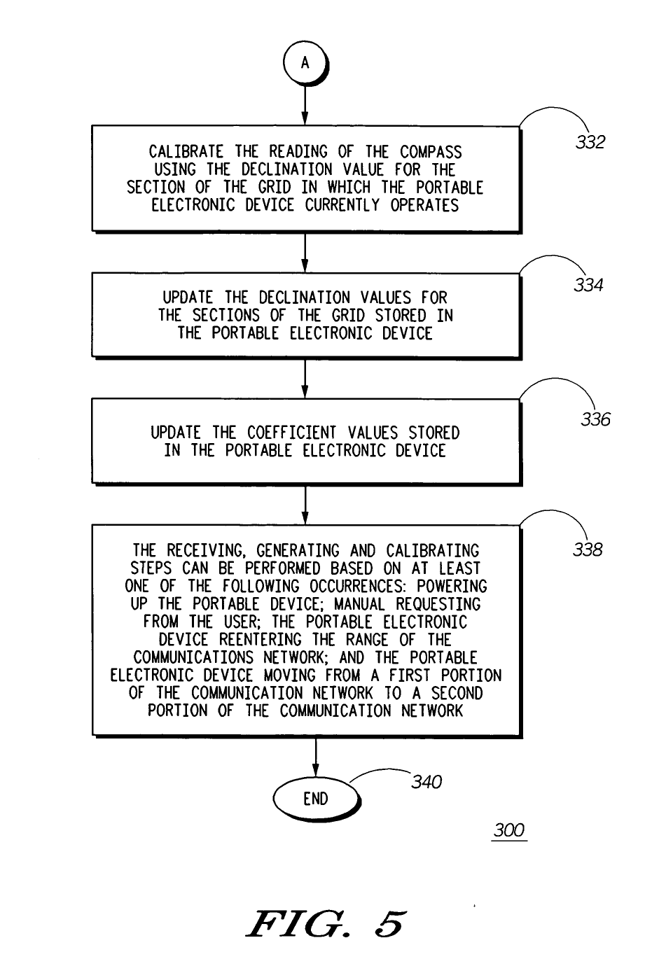

Referring back to FIGS. 1 and 2, an example will be presented to describe the steps 316-327 of the method 300. Reference will also be made to FIG. 4 here. In FIG. 4, a portion of a grid 400 having one or more sections 410, which are represented by dashed or broken lines, can be assigned to a geographical region 412. The geographical region 412 can be any suitable part of the earth, and contours 414 of the earth's magnetic field are pictured. Each contour 414 can have a numerical designation that represents its deviation or declination from true north. Those of skill in the art will appreciate that these values may change over time.

In one arrangement, each section 410 can extend to the right and to the left of a particular contour 414. Each section 410 may also extend for a predetermined distance in a vertical, or north-south, direction. For example, a section 410 marked with diagonal lines can cover a portion of the grid 400 that extends for a predetermined distance in a vertical direction and to both the right and left of the contour 414 having a declination degree of zero. Thus, any portion of the geographical region 412 that is contained within this section 410 having the diagonal lines can be considered to have a declination of zero degrees.

In another arrangement, a representation of the grid 400 can be downloaded to the portable electronic device 114. For example, the representation of the grid 400 can be programmed into the memory 124 at the time the portable electronic device 114 is manufactured. Of course, the representation of the grid 400 can be transferred to the portable electronic device 114 in any other suitable fashion, such as its transmission from the communications network 110 or some other network or device.

A positional marking can be assigned to one or more of the sections 410 of the grid 400. For example, positional coordinates can be assigned to each section 410 of the grid 400. In one arrangement, the positional coordinates can be the latitude and longitude of the geographical center of the relevant section 410 or some other suitable portion(s) of such a section 410. The positional markings may be in other suitable forms, such as one or more area codes or postal delivery codes. The positional markings that are associated with the sections 410 can be downloaded to the portable electronic device 114 in a fashion similar to how the representation of the grid 400 is done, including at the time of manufacture or over the communications network 110 or some other network or device at a later time.

A declination value can also be assigned to one or more sections 410 of the grid 400. For example, the section 410 that is marked with the diagonal lines can be given a declination value of zero degrees. Other sections 410 can be assigned declination values based on, for example, the contours 414 that the sections 410 cover or are closest to. These declination values can be stored in the portable electronic device 114, such as in the memory 124. In addition, the declination values can be transferred to the portable electronic device 114 in accordance with any suitable manner, including those described above with respect to the transfer of the representation of the grid 400 and the positional markings.

When the portable electronic device 114 is in the boundary of the grid 400, the communication network 110, such as one of the base stations 112, can transmit to the portable electronic device 114 geographical positional information. As an example, this geographical positional information can be the positional coordinates of the base station 112 (or some other suitable device) transmitted over the BCCH. The area code or postal delivery code in which the base station 112 sits may also be the geographical positional information.

This received geographical positional information can be compared to the positional markings that are associated with the sections 410. For example, the processor 118 can compare the geographical positional information that is received with the positional markings associated with the sections 410 that are stored in the memory 124. The processor 118 can then, for example, determine which of the stored positional markings is geographically closest to the received geographical positional information. Based on this comparison, the processor 118 can select from the memory 124 the declination value that is associated with the section 410 of the grid 400 whose assigned positional marking was closest. At this point and as will be explained below, a calibration of a reading for the compass 126 may be performed, but first, another example of generating declination values in accordance with the steps 328 and 329 (see FIG. 3) will be discussed.

Referring to FIGS. 1 and 2, declination coefficients that are associated with at least one region of the earth can be transmitted to the portable electronic device 114. The declination coefficients can be programmed and stored in the memory 124 when the portable electronic device 114 is manufactured. In addition, the declination coefficients can be downloaded to the portable electronic device 114 sometime thereafter, such as from the communications network 100 or some other suitable network or device. As is known in the art, these declination coefficients are widely available and can be obtained from various scientific or government organizations.

Along with the declination coefficients, a declination model or algorithm to assist in generating declination values can be downloaded into the memory 124 of the portable electronic device 114. Suitable examples include the Department of Defense World Magnetic Model and its declination coefficients and the International Geomagnetic Reference Field Model and its accompanying declination coefficients, both of which can be acquired from the International Association of Geomagnetism and Aeronomy. Of course, other suitable declination models can be obtained.

The processor 118 can use the declination coefficients and the declination model to generate declination values. For example, when the portable electronic device 114 enters a particular geographic region, the portable electronic device 114 can receive geographical positional information related to this region. As an example, a base station 112 of the communications network 110 can transmit such geographical positional information to the receiver 120 when the portable electronic device 114 is within the operating range of the base station 112. The receiver 120 can process and forward this information to the processor 118.

The geographical positional information can be positional coordinates, such as latitude and longitude, of the base station 112. As another example, the geographical positional information can be an area code or a postal delivery code in which the base station 112 is situated. It is understood, however, that the invention is not so limited, as the geographical positional information can include any information that provides at least a general indication as to the physical location of the portable electronic device 114 and can be received from any suitable source.

The processor 118 can access from the memory 124 the declination model and the declination coefficients and, using the received geographical information, can generate the declination value. The generation of the declination value can occur in virtually any part of the world so long as geographical positional information can be provided to the portable electronic device 114. Although two different ways to generate declination values have been presented, the invention is not restricted as such. Virtually any type of method can be used to generate the declination values.

Referring back to the method 300 of FIG. 3, at step 330, the reading for a compass can be calibrated using the declination value, and the receiving, generating and calibrating steps may occur in the portable electronic device containing the compass. In one arrangement, at step 332 of FIG. 4 (through jump circle A), the reading of the compass can be calibrated using the declination value for the section of the grid in which the portable electronic device currently operates.

Referring to FIGS. 1, 2 and 4, the processor 118, in accordance with the above discussion, can obtain a declination value, which may be assigned to the section 410 of the grid 400 in which the portable electronic device 114 currently operates. The processor 118 can then calibrate the reading that it receives from the compass 126 based on the selected declination value. The processor 118 can calibrate the compass reading in accordance with any number of well-known methods.

Turning to the second method of generating declination values (see steps 328 and 329 of FIG. 3), the processor 118 can calibrate the reading from the compass 126 using the generated declination value. Again, the processor 118 can employ any number of well-known methods to calibrate the reading from the compass 126. In either arrangement, the processor 118 can cause the updated reading to be displayed on the display 128 or broadcast over the speaker 130 or otherwise provided to a user through any suitable user interface. As explained previously, the updated reading can provide a more accurate reading of true north or some other reference point. Also in either arrangement, the process of receiving the geographical positional information, generating the declination values and calibrating the reading of the compass 126 can all be performed at the portable electronic device 114.

Referring back to FIG. 4, at step 334, the declination values for the sections of the grid that are stored in the portable electronic device can be updated. In addition, at step 336, the coefficient values that are stored in the portable electronic device can be updated. This process of updating is an option, but it can be useful as the magnetic field of the earth changes over time.

For example, referring to FIGS. 1, 2 and 4, the declination values that are associated with the sections 410 and/or the declination coefficients, both of which may be stored in the memory 124 of the portable electronic device 114, can be periodically updated. In one arrangement, the updates can be received from the communications network 110. The receiver 120 can receive the updates, process them and can send them to the processor 118. The processor 118 can then cause the declination values and/or declination coefficients in the memory 124 to be updated. Other ways to update the declination values and the declination coefficients are envisioned, including the process of having a user download the updates from a computer or some other location or device.

Referring back to the method 300 of FIG. 4, at step 338, the receiving, generating and calibrating steps can be performed based on at least one of the following occurrences: powering up the portable electronic device; manual requesting from the user; the portable electronic device reentering the range of the communications network; and the portable electronic device moving from a first portion of the communications network to a second portion of the communications network. The method 300 can end at step 340. Reference will once again be made to FIGS. 1 and 2 to describe this process.

To save battery life, the process of adjusting the readings from the compass 126 can be performed when certain events occur. For example, the adjustment of the readings, in accordance with the steps described above, can be performed when the portable electronic device 114 is turned on. Alternatively, a user, through the display 128, the keypad 132 or some other suitable user interface, can request the adjustment for the readings of the compass 126. Moreover, the portable electronic device 114 may leave an operating range of, for example, the communications network 110, and an adjustment of readings for the compass 126 can occur when the portable electronic device reenters the operating range of the communications network 110.

The adjustment process may also be performed when the portable electronic device 114 moves from a first portion of the communications network 110 to a second portion of the communications network 110. As an example, the first portion can be a cell 115 (see FIG. 1) in the communications network 110, which, as is known in the art, can define the range of a base station 112, and the second portion can be another cell 115. As the portable electronic device 114 moves from one cell 115 to another cell 115, adjustments can be made to the readings of the compass 126. It is understood, however, that other suitable events or occurrences can trigger the adjustment process in addition to those listed here.

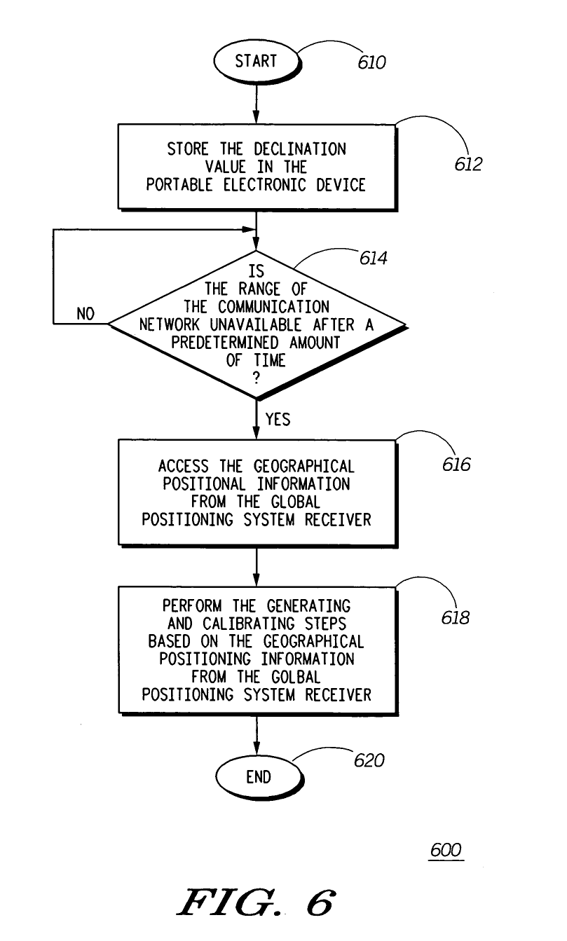

Referring to FIG. 6, a method 600 that illustrates how a global positioning system may assist in adjusting readings from a compass is shown. At step 610, the method 600 can start. Similar to the method 300, reference will be made to FIGS. 1 and 2, although it is understood that the method 600 can be implemented in any other suitable device or system. Moreover, the invention is not limited to the order in which the steps are listed in the method 600. In addition, the method 600 can contain a greater or a fewer number of steps than those shown in FIG. 6.

At step 612, the declination value can be stored in the portable electronic device. At decision block 614, it can be determined whether the portable electronic device has left the range of the communication network after a predetermined amount of time. If it has not, the method 600 can resume at decision block 614. If it has, however, the method 600 can continue at step 616, where the geographical positional information can be accessed from a global positioning system receiver. Further, at step 618, the generating and calibrating steps can be performed based on the geographical positioning information from the global positioning system receiver. The method 600 can then end at step 610.

For example, referring to FIGS. 1-3 and 5, a declination value can be obtained in accordance with the method 300 (or some other suitable method) and stored in the memory 124 of the portable electronic device 114. As noted earlier, the portable electronic device 114 may acquire geographical positional information from the communications network 110. There is a possibility, however, that the communications network 110 may become unavailable, such as when the portable electronic device 114 moves beyond the range of the communications network 110 or the communications network may be malfunctioning. At this point, the portable electronic device 114 may no longer be able to obtain the geographical positional information from the communications network 110.

In this event, the processor 118 can obtain the geographical positional information from the GPS receiver 134. The processor 118 can then generate a new declination value in accordance with one of the examples described in relation to the method 300, for example, and can use the new declination value to calibrate the readings from the compass 126. In one arrangement, the step of generating a new declination value based on positional information from the GPS receiver 134 can be triggered after the portable electronic device 114 has been outside the range of, for example, the communications network 110 for a predetermined amount of time. It must be noted that other devices or methods can be used to supply the portable electronic device 114 with the geographical positional information when the portable electronic device moves outside the range of the communications network 110.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for providing adjustments for a compass, comprising:
receiving geographical positional information from a communications network;
generating a declination value based on the geographical positional information; and
calibrating a reading for the compass using the declination value, wherein the receiving, generating and calibrating steps are performed at a portable electronic device containing the compass.

2. The method according to claim 1, further comprising:
assigning a grid to a geographical area;
assigning a positional marking to sections of the grid;
assigning a declination value for the sections of the grid; and
transmitting to the portable electronic device the geographical positional information associated with the section of the grid in which the portable electronic device currently operates.

3. The method according to claim 2, wherein the step of generating a declination value comprises comparing the received geographical positional information with the positional markings and selecting an assigned declination value based on the comparing step and the step of calibrating the reading of the compass comprises calibrating the reading of the compass using the selected declination value for the section of the grid in which the portable electronic device currently operates.

4. The method according to claim 3, further comprising storing in the portable electronic device the assigned declination values for the sections of the grid.

5. The method according to claim 4, further comprising periodically updating the assigned declination values for the sections of the grid stored in the portable electronic device.

6. The method according to claim 1, further comprising:
storing in the portable electronic device at least one declination model and declination coefficients that are associated with at least one region of the earth; and
using the declination model and the declination coefficients to generate the declination value.

7. The method according to claim 6, further comprising periodically updating the declination coefficient stored in the portable electronic device.

8. The method according to claim 1, wherein the receiving, generating and calibrating steps are performed based on at least one of the following occurrences:
powering up the portable electronic device;
manual requesting from a user;
the portable electronic device reentering a range of the communications network; and
the portable electronic device moving from a first portion of the communications network to a second portion of the communication network.

9. The method according to claim 1, further comprising:
storing the declination value in the portable electronic device;
when the communication network is unavailable and after a predetermined amount of time, accessing the geographical positional information from a global positioning system receiver; and
performing the generating and calibrating steps based on the geographical positioning information from the global positioning system receiver.

10. The method according to claim 1, wherein the geographical positioning information is based on at least one of latitudinal and longitudinal coordinates, an area code and a postal delivery code.

11. A system for providing compass adjustments, comprising:
a compass, wherein the compass provides directional information;
a receiver, wherein the receiver receives geographical information from a communications network; and
a processor coupled to the compass and the receiver, wherein the processor is programmed to generate a declination value based on the geographical positional information and to calibrate a reading for the compass using the declination value;
wherein the compass, the receiver and the processor are part of a portable electronic device.

12. The system according to claim 11, wherein a grid is assigned to a geographical area, a positional marking is assigned to sections of the grid and declination values are assigned to the sections of the grid;
wherein a transmitter in the communications network transmits to the portable electronic device the geographical positional information associated with the section of the grid in which the portable electronic device currently operates.

13. The system according to claim 12, wherein the processor is further programmed to compare the received geographical positional information with the positional markings, to select an assigned declination value based on the comparison and to calibrate the reading for the compass using the selected declination value for the section of the grid in which the portable electronic device currently operates.

14. The system according to claim 13, wherein the portable electronic device further comprises a memory coupled to the processor, wherein the memory stores the assigned declination values.

15. The system according to claim 14, wherein the processor is further programmed to periodically update the assigned declination values stored in the memory.

16. The system according to claim 11, wherein the portable electronic device further comprises a memory, wherein the memory stores at least one declination model and declination coefficients that are associated with at least one region of the earth and wherein the processor is further programmed to use the declination model and the declination coefficients to generate the declination value.

17. The system according to claim 16, wherein the processor is further programmed to update the declination coefficients stored in the portable electronic device.

18. The system according to claim 11, wherein the processor is further programmed to generate the declination values and calibrate the reading for the compass based on at least one of the following occurrences:
powering up the portable electronic device;
manual requesting from a user;
the portable electronic device reentering a range of the communications network; and
the portable electronic device moving from a first portion of the communications network to a second portion of the communication network.

19. The system according to claim 11, further comprising a global positioning system receiver, wherein the processor if further programmed to:
after a predetermined amount of time, access the geographical positional information from the global positioning system receiver when the communication network is unavailable; and
perform the generating and calibrating steps based on the geographical positioning information from the global positioning system receiver.

20. The system according to claim 11, wherein the geographical positioning information is based on at least one of latitudinal and longitudinal coordinates, an area code and a postal delivery code.
